(19) United States
(12) Patent Application Publication
(10) Pub. No.: US 2026/0079141 A1
(43) Pub. Date: Mar. 19, 2026

(54) VALIDATION OF CHROMATOGRAPHIC PROCEDURES

(71) Applicant: Dionex Softron GmbH, Germering (DE)

(72) Inventors: Martin Rendl, Munich (DE); Anne Morgenstern, Gilching (DE)

(21) Appl. No.: 18/954,750

(22) Filed: Nov. 21, 2024

Related U.S. Application Data
(60) Provisional application No. 63/694,943, filed on Sep. 16, 2024.

(51) Int. Cl. G01N 30/86; G01N 30/02

(52) U.S. Cl. CPC G01N 30/8675; G01N 30/8651; G01N 2030/027

(57) ABSTRACT

The present invention relates to a method to validate at least one chromatographic procedure, wherein the method comprises: a data processing device validating a plurality of parameters relating to the at least one chromatographic procedure, wherein the validating comprises the data processing device checking whether at least one boundary condition is met. The present invention also relates to a corresponding system, computer program, computer-readable medium and data carrier signal.

### CROSS REFERENCE TO RELATED APPLICATION

This application claims the benefit of U.S. Provisional Application Ser. No. 63/694,943, filed Sep. 16, 2024, which is incorporated by reference in its entirety.

### BACKGROUND

The present invention relates to chromatographic procedures.

In the field of chromatography, in particular in the fields of (ultra) high performance liquid chromatography ((U)HPLC) there is an increasing demand to increase the throughput of sample analyses to reduce the time to result as well as efficiency. This may be achieved by employing workflows such as tandem LC, that allow to parallelize certain steps of the sample analysis. Thus, a plurality of separation columns is employed in a single HPLC instrumentation. However, it is beneficial that the quality of the analysis is not compromised in such a workflow scenario and to avoid unplanned downtimes.

Generally, it is an object of the present invention to increase the efficiency of running chromatographic procedures. In particular, the downtimes should be reduced and the resource utilization should be increased.

These objects are met be the present invention.

According to a first aspect, the present invention relates to a method to validate at least one chromatographic procedure, wherein the method comprises: a data processing device validating a plurality of parameters relating to the at least one chromatographic procedure, wherein the validating comprises the data processing device checking whether at least one boundary condition is met.

That is, embodiments of the present technology relate to validating a chromatographic procedure (or a plurality of such procedures) by means of a data processing device. In particular, the chromatographic procedure(s) may be validated before the procedure(s) actually being performed by a chromatography system. In this regard, a plurality of parameters may be validated. For example, the parameters may include a flow rate and a pressure limit, in particular an upper pressure limit. In embodiments of the present technology, the at least one boundary condition may be determined by means of the flow rate and/or the pressure limit. For example, the boundary condition may be that a maximum flow rate does not result in an expected pressure exceeding the upper pressure limit.

Thus, the parameters may be validated. A result of the validation may be output to the user. Further, the chromatographic procedure may only be operated in case of a successful validation.

Thus, embodiments of the present technology may reduce the downtime of a system. Without such a validation, it may occur that a chromatographic procedure is performed beyond the limits of the system. For example, a chromatographic system may have an upper pressure limit of 1000 bar, but the chromatographic procedure and in particular the flow rate may lead to a pressure of 1500 bar. This may lead to the procedure being stopped, or worse, to damage on the system. Both may require an additional user intervention, and potentially even an exchange of components of the system (e.g., in case the component has been damaged).

This may be eliminated (or at least substantially reduced) by the present invention. Instead of just operating the chromatographic procedure, the procedure and particularly its parameters are validated before operating the procedure. This typically decreases the failure rate and the down time and thus leads to a more robust operation of the system and to increased efficiency.

In other words, embodiments of the present technology may achieve enhanced throughput at simultaneously uncompromised quality of the chromatographic results. Robust workflows may thus be defined that are tailored to a given instrumentation. Embodiments of the invention are easy of use, and instrument methods/workflows may be validated automatically to ensure applicability to given instrumentation. Embodiments of the present invention may lead to reduced unplanned downtime. Thus, no (or fewer) instrument methods are executed that would ultimately fail during execution due to incompatibility with given instrumentation.

For each chromatographic procedure, the plurality of parameters may comprise at least one flow rate.

For each chromatographic procedure, the plurality of parameters may comprise at least one solvent composition.

For each chromatographic procedure, the plurality of parameters may comprise at least one pressure limit.

Each at least one pressure limit may be an upper pressure limit.

Each at least one pressure limit may be a lower pressure limit.

For each chromatographic procedure, the plurality of parameters may comprise at least one column temperature.

For each chromatographic procedure, the plurality of parameters may comprise at least one sample drawing rate, a solvent needle washing composition, and/or a procedure duration.

The validating may comprise determining an operational pressure, wherein the determining is based on the at least one flow rate, and wherein the at least one boundary condition comprises the operational pressure being in a pressure range defined by the at least one pressure limit; or the validating may comprise determining at least one flow rate limit, wherein the determining is based on the at least one pressure limit, and wherein the at least one boundary condition comprises the at least one flow rate being in a flow rate range defined by the at least one flow rate limit.

It will be understood that the operational pressure is an expected pressure, i.e., it is the pressure expected when operating the system according to the parameters (in particular according to the flow rate).

Further, the following will be understood. If an upper pressure limit is provided, the boundary condition typically is that the operational pressure is not above the upper pressure limit, i.e., the upper pressure limit will typically be the upper end of the pressure range. If a lower pressure limit is provided, the boundary condition typically is that the operational pressure is not below the lower pressure limit, i.e., the lower pressure limit will typically be the lower end of the pressure range.

If an upper pressure limit is provided, this may lead to an upper flow rate limit of the flow rate range, i.e., the boundary condition may then typically be that the at least one flow rate does not exceed the upper flow rate limit of the flow rate range. Conversely, if a lower pressure limit is provided, this may lead to a lower flow rate limit of the flow rate range, i.e., the boundary condition may then typically be that the at least one flow rate is not lower than the lower flow rate limit of the flow rate range.

Determining the operational pressure or determining the at least one flow rate limit may be based on the at least one solvent composition.

Determining the operational pressure or determining the at least one flow rate limit may be based on the at least one column temperature.

Determining the operational pressure or determining the at least one flow rate limit may be based on at least one fluidic resistance of a system for performing the at least one chromatographic procedure.

The at least one fluidic resistance of the system may be determined at different times. In this regard, it was found that the fluidic resistance may change over time. For example, a chromatographic column, when being operated with a certain solvent and under a certain temperature, may initially have a fluidic resistance of, e.g., 10 bar/(μL/min). However, after a certain time or after a certain number of chromatographic runs, it may have a fluidic resistance of, e.g., 15 bar/(μL/min). For example, its packing material may deteriorate and cause this change. It may thus be beneficial not to assume a constant fluidic resistance, but to repeatedly determine the fluidic resistance at different times.

At least one boundary condition may be defined by a range with at least one end, and the method may further comprise the data processing device determining a distance from the at least one end. The distance may be a relative distance.

For example, the at least one boundary condition may be defined by an upper pressure limit. As a mere example, the upper pressure limit may be 1000 bar. The boundary condition may thus be that the operational pressure of the chromatographic procedure is in the range defined by an upper limit of 1000 bar. The highest operational pressure to be expected (e.g., based on the flow rate, the solvent composition and the fluidic resistance) may be, e.g., 600 bar. In this case, the distance from the end limit (1000 bar) would be 400 bar, or 400 bar/1000 bar=0.4. Thus, this distance may be an indication for the robustness of the chromatographic procedure, and the greater the relative distance, the more robust the chromatographic procedure, as a deviation from the expected operational parameters is less likely to go beyond the boundary conditions the higher the distance is. Determining the distance (and optionally outputting the distance to indicate it to the user) may thus enable the user to consider whether the operational parameters are ideally chosen or whether the user wishes to change the operational parameters (to arrive at a greater distance). This may further reduce the downtime, as it may generally lead to the user selecting relatively high distances and only operating the system with small distances if necessary.

The method may further comprise the data processing device receiving at least some of the parameters by a user input.

The method may further comprise: the data processing device retrieving at least some of the parameters from a memory, these parameters relating to parameters of at least one previously defined chromatographic procedure.

That is, in embodiments of the present invention, the parameters of the chromatographic procedure may be input by a user. However, embodiments of the present invention also allow that the parameters are retrieved from a memory to which the data processing device has access. That is, the present technology also allows previously defined chromatographic runs to be validated. This may be particularly useful, e.g., in case a component of the chromatography system (e.g., the separation column) has been changed.

The method may further comprises: if the validation fails, a user interface outputting an error message to a user.

The validation may fail if the check whether at least one boundary condition is met is not successful.

The method may further comprise: the user interface outputting the distance to the user.

The method may further comprise: after a successful validation, a chromatographic system performing the at least one chromatographic procedure. That is, whether or not the at least one chromatographic procedure is performed may be conditional on the validation, and the at least one chromatographic procedure may only be performed in case of a successful validation.

The data processing device may be a processor.

Another aspect of the invention relates to a system comprising a data processing device, wherein the system is configured to perform the described method.

A still further aspect of the invention relates to a computer program comprising instructions which, when the program is executed by a data processing device, cause the data processing device to carry out the described method.

A still further aspect of the invention relates to a computer-readable medium comprising instructions which, when executed by a data processing device, cause the data processing device to carry out the described method.

A still further aspect of the invention relates to a data carrier signal carrying the described computer program.

The invention is also defined by the following numbered embodiments.

Below, method embodiments will be discussed. These are abbreviated by the letter “M” followed by a number. Whenever reference is herein made to method embodiments, these embodiments are meant.
M1. A method to validate at least one chromatographic procedure, wherein the method comprises:
a data processing device validating a plurality of parameters relating to the at least one chromatographic procedure, wherein the validating comprises the data processing device checking whether at least one boundary condition is met.
M2. The method according to embodiment M1,
wherein for each chromatographic procedure, the plurality of parameters comprises at least one flow rate.
M3. The method according to any of the preceding embodiments,
wherein for each chromatographic procedure, the plurality of parameters comprises at least one solvent composition.
M4. The method according to any of the preceding embodiments,
wherein for each chromatographic procedure, the plurality of parameters comprises at least one pressure limit.
M5. The method according to the preceding embodiment,
wherein each at least one pressure limit is an upper pressure limit.
M6. The method according to embodiment M4,
wherein each at least one pressure limit is a lower pressure limit.
M7. The method according to any of the preceding embodiments,
wherein for each chromatographic procedure, the plurality of parameters comprises at least one column temperature.
M8. The method according to any of the preceding embodiments,
wherein for each chromatographic procedure, the plurality of parameters comprises at least one sample drawing rate, a solvent needle washing composition, and/or a procedure duration.
M9. The method according to any of the preceding embodiments with the features of embodiment M2 and M4,
wherein the validating comprises determining an operational pressure, wherein the determining is based on the at least one flow rate, and wherein the at least one boundary condition comprises the operational pressure being in a pressure range defined by the at least one pressure limit; or
wherein the validating comprises determining at least one flow rate limit, wherein the determining is based on the at least one pressure limit, and wherein the at least one boundary condition comprises the at least one flow rate being in a flow rate range defined by the at least one flow rate limit.

In this regard, the following will be understood. If an upper pressure limit is provided, the boundary condition typically is that the operational pressure is not above the upper pressure limit, i.e., the upper pressure limit will typically be the upper end of the pressure range. If a lower pressure limit is provided, the boundary condition typically is that the operational pressure is not below the lower pressure limit, i.e., the lower pressure limit will typically be the lower end of the pressure range.

Similarly, if an upper pressure limit is provided, this may lead to an upper flow rate limit of the flow rate range, i.e., the boundary condition may then typically be that the at least one flow rate does not exceed the upper flow rate limit of the flow rate range. Conversely, if a lower pressure limit is provided, this may lead to a lower flow rate limit of the flow rate range, i.e., the boundary condition may then typically be that the at least one flow rate is not lower than the lower flow rate limit of the flow rate range.
M10. The method according to the preceding embodiment and with the features of embodiment M3,
wherein determining the operational pressure or determining the at least one flow rate limit is based on the at least one solvent composition.
M11. The method according to any of the 2 preceding embodiments and with the features of embodiment M7,
wherein determining the operational pressure or determining the at least one flow rate limit is based on the at least one column temperature.
M12. The method according to any of the 3 preceding embodiments,
wherein determining the operational pressure or determining the at least one flow rate limit is based on at least one fluidic resistance of a system for performing the at least one chromatographic procedure.
M13. The method according to the preceding embodiment,
wherein the at least one fluidic resistance of the system is determined at different times.
M14. The method according to any of the preceding embodiments,
wherein at least one boundary condition is defined by a range with at least one end,
wherein the method further comprises
   the data processing device determining a distance from the at least one end.
M15. The method according to the preceding embodiment, wherein the distance is a relative distance.
M16. The method according to any of the preceding embodiments, wherein the method further comprises:
the data processing device receiving at least some of the parameters by a user input.
M17. The method according to any of the preceding embodiments, wherein the method further comprises:
the data processing device retrieving at least some of the parameters from a memory, these parameters relating to parameters of at least one previously defined chromatographic procedure.
M18. The method according to any of the preceding embodiments, wherein the method further comprises:
if the validation fails, a user interface outputting an error message to a user.
M19. The method according to the preceding embodiment,
wherein the validation fails if the check whether at least one boundary condition is met is not successful.
M20. The method according to any of the 2 preceding embodiments and with the features of embodiment M14, wherein the method further comprises:
the user interface outputting the distance to the user.
M21. The method according to any of the preceding embodiments, wherein the method further comprises:
after a successful validation, a chromatographic system performing the at least one chromatographic procedure.
M22. The method according to any of the preceding embodiments, wherein the data processing device is a processor.
S1. A system comprising a data processing device, wherein the system is configured to perform the method according to any of the preceding embodiments.
C1. A computer program comprising instructions which, when the program is executed by a data processing device, cause the data processing device to carry out the method according to any of the preceding method embodiments.
C2. A computer-readable medium comprising instructions which, when executed by a data processing device, cause the data processing device to carry out the method according to any of the preceding method embodiments.
C3. A data carrier signal carrying the computer program of embodiment C1.

Preferred embodiments of the invention will now be described with reference to the Figure.

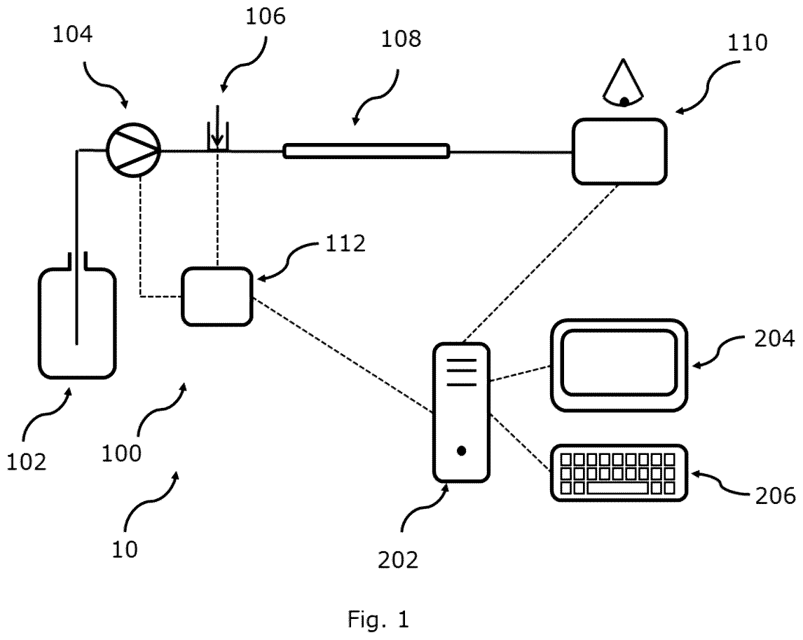

FIG. 1 depicts a system according to a preferred embodiment of the present invention.

FIG. 1 depicts a system 10 for performing a chromatographic procedure. The system 10 comprises a chromatography system 100, as well as a data processing device 202. The chromatography system 100 comprises a solvent reservoir 102, a pump 104, a sample injection device 106, a column 108, and a detector 110. These components are fluidly connected to one another by fluid connections, as depicted by solid lines. The chromatography system 100 further comprises a controller 112 for controlling the chromatography system. As depicted by dashed lines, the controller 112 is coupled to the pump 104 and to the sample injection device 106.

The controller 112 can include a data processing unit and may be configured to control the chromatography system 100 and carry out particular method steps. The controller can send or receive electronic signals for instructions. The controller can also be referred to as a microprocessor. The controller can be contained on an integrated-circuit chip. The controller can include a processor with memory and associated circuits. A microprocessor is a computer processor that incorporates the functions of a central processing unit on a single integrated circuit (IC), or sometimes up to a plurality of integrated circuits, such as 8 integrated circuits. The microprocessor may be a multipurpose, clock driven, register based, digital integrated circuit that accepts binary data as input, processes it according to instructions stored in its memory and provides results (also in binary form) as output. Microprocessors may contain both combinational logic and sequential digital logic. Microprocessors operate on numbers and symbols represented in the binary number system.

While a particular chromatography system 100 is depicted in FIG. 1, the skilled person will understand that the details of the chromatography system 100 are not limiting. For example, while a single solvent reservoir 102 is depicted in FIG. 1, it will be understood that two (or more) different solvents may be used, e.g., in a gradient operation. Furthermore, while a single column 108 is depicted, it should also be understood two (or more) columns may be used, e.g., in a tandem operation.

Furthermore, the system 10 comprises a data processing device 202, an output device 204 (e.g., a monitor) and an input device 206 (e.g., a keyboard). As depicted by dashed lines, the data processing device 202, which may be or comprise a processor, may be operatively coupled to the output device 202, the input device 206, the controller 112 and to the detector 110.

The chromatography system 100 may be operated according to one or more chromatographic procedures, which may also be referred to as workflows. Embodiments of the present technology refer to the data processing device 202 validating a plurality (i.e., at least two) parameters relating to the one or more chromatographic procedures. This validation comprises the data processing device 202 checking whether at least one boundary condition is met.

For execution of a typical procedure workflow in the field of chromatography (e.g., UHPLC) a plurality of execution parameters may be specified by the user in the form of an instrument method. For example, the user may input such parameters by means of the input device 206. Among those are for instance parameters specific for the sample handling such as draw speed, needle washing with specific solvents and duration etc. Furthermore, the following parameters for the actual chromatographic separation may be specified:
flow rate(s);
solvent composition(s);
Upper/lower pressure limit;
Column compartment temperature.

Depending on the choice of those parameters, it may occur that an instrument method is created that is not compatible with the actual configuration of the chromatography system 100. For instance, a user may specify a flow rate of 0.1 mL/min for an aqueous solvent (100% v/v aqueous), an upper pressure limit of 500 bar and a column temperature of 50° C. (all these being parameters relating to the chromatographic procedure). In the case that the HPLC system 100 has a fluidic resistance of 10 bar/(μL/min) predominately originating from the column 108 (also referred to as separation column) which is thermostatted at 50° C., the pressure that results from a flow rate of 0.1 mL/min would be about 1000 bar. It thus would exceed the specified upper pressure limit significantly and would result in an immediate stop upon execution of the chromatographic analysis.

In other words, a user may input the parameters described above by means of the input device 206. The data processing device 202 would then validate these parameters. More specifically, the upper pressure limit of 500 bar may be a boundary condition, i.e., the boundary condition would be that the chromatography system 10 should not be operated with a pressure exceeding 500 bar. Further, based on the flow rate (0.1 mL/min), the temperature (50° C.) and the corresponding fluidic resistance (10 bar/(μL/min)), an operational pressure may be determined, which would result in approximately 1000 bar in the described example. The operational pressure expected when employing the described procedure thus exceeds the upper pressure limit and the boundary condition is thus not met, resulting in the validation failing.

In a different scenario, a user might run an instrument method employing a flow rate of 0.1 mL/min for an aqueous solvent (100% v/v aqueous), an upper pressure limit of 1500 bar and a column temperature of 50° C. using a HPLC instrument that has a fluidic resistance of 10 bar/(μL/min) predominately originating from the separation column 108 which is thermostatted at 50° C. At this flow rate the resulting pressure would be about a 1000 bar and thus significantly below the pressure limit of the system of 1500 bar. Again, these parameters may be provided to the data processing device 202 (e.g., by the user inputting these parameters by means of the data input device 206), and the data processing device 202 may validate these parameters. Again, an operational pressure (here, 1000 bar) may be determined based on the flow rate, the type of solvent, the column temperature and the corresponding fluidic resistance, and it is checked whether this operational pressure does not exceed the pressure limit of 1500 bar (this being the boundary condition). In the described example, the boundary condition is met, such that the parameters are positively validated, i.e., the validation succeeds.

However, if the same instrument method would be employed for a column that is thermostatted at a temperature of only 30° C. rather than 50° C., this may cause a significantly higher backpressure (particularly originating from the separation column) due to the increase in the viscosity of the solvent(s). In particular, the fluidic resistance may be higher, and it should be understood that the fluidic resistance may generally be temperature dependent (and also solvent dependent). For example, the fluidic resistance at 30° C. may be 20 bar/(μL/min), such that the above example at a temperature of 30° C. would result in an expected operational pressure of 2000 bar. Thus, it may occur that the pressure limit of 1500 bar is exceeded. If running such a chromatographic procedure without any validation, this would cause the instrument (also referred to as chromatography system) to stop.

Embodiments of the herein presented approach aim to prevent generation or execution of instrument methods that are not compatible with the actual chromatography instrumentation. That is, in embodiments of the present technology, a plurality of parameters relating to a chromatographic procedure are validated by a data processing device. This allows the parameters (and thus the chromatographic procedure) to be validated before actually performing the chromatographic procedure. Further, it will be understood that the chromatographic procedure is typically only performed if the validation succeeds, i.e., if the parameters are successfully validated, i.e., when the boundary condition(s) is/are met. Overalls, this may result in fewer failed chromatographic procedure and a higher up time of the chromatography system 100, and thus to an improved utilization of resources.

Generally, different cases for such instrument method validation may be realized:
Check already existing instrument methods against current device configuration and prevent execution if not compatible.
Check instrument method parameter ranges during programing of instrument method to assure that instrument method is compatible with current instrument configuration.

In the latter case, the data processing device 202 (see FIG. 1) may receive the parameters by a user input, e.g., by means of the data input device 206.

In the former case, at least some of the parameters may already be stored in a memory that is accessible by the data processing device 202. For example, there may be a chromatographic procedure stored in a memory. For further example, it may also be possible that this chromatographic procedure has already been performed. However, it is possible that since the last operation of the chromatographic procedure, a component in the chromatography system 100 has changed. For example, it is possible that the chromatographic column 108 was changed, and the newly inserted chromatographic column 108 may have a fluidic resistance different from the fluidic resistance of the column that was present when the procedure was last performed. In such a scenario, the validation method may be performed. Further, it is also possible that the validation method is performed if no component has been changed in the system to just validate the chromatographic procedures stored in the memory.

Generally, the maximum applicable flow rate f_{system,max} for the given (current) instrumentation is determined as

$${F}_{system , max} = {P}_{max} / {R}_{sys}$$

where Pₘₐₓ is the upper pressure limit of the system and R_{sys} is the fluidic resistance of the system. The latter value R_{sys} may preferably be determined empirically. Alternatively, R_{sys} may be based on values associated for each fluidic component of the HPLC instrumentation. Hence, R_{sys} would be the sum of all resistance values Rᵢ of the subunits of the relevant fluidic flowpath i.e., R_{sys}=ΣRᵢ (assuming that the components are arranged in series as in FIG. 1). In the case of fluidic connections such as capillaries the nominal fluidic resistance may be calculated as follows. The nominal (calculated) backpressure ΔPₙₒₘ across a fluid conduit (element) can be calculated using the Hagen-Poiseuille equation:

$$Δ {P}_{nom} = 8 μ LQ / π {R}^{4}$$

where:
ΔP is the (back) pressure drop across the fluid conduit
L is the length of the conduit (pipe),
μ is the dynamic viscosity,
Q is the volumetric flow rate,
R is the radius of the conduit (pipe).

It should be understood that the dynamic viscosity is solvent dependent and temperature dependent. Thus, the pressure across a fluidic element (such as a conduit) depends, inter alia, on the solvent and the temperature.

Further, in the case of chromatography columns, it is more complex to obtain the respective fluidic resistance. That is, the Hagen-Poiseuille equation may not be readily applicable to the columns. However, information relating to the fluidic resistance may be provided. For example, the fluidic resistance of the column 108 may be stored on a column information tag (such as NFC, RFID tags). Again, it should be understood that the fluid resistance is typically not a single value, but a plurality of values, depending on the temperature and the solvent that is used. Furthermore, the fluidic resistance of columns may change over time, due to alteration of the packing material or agglomeration of particulate matter within or at the entrance of the column. Thus, embodiments of the present technology also relate to empirical determination of the fluidic resistance in certain intervals, as this may be the most robust means for obtaining R_{sys}. In other words, in embodiments of the present invention, the fluidic resistance may be determined at different times, e.g., in certain intervals and/or after a certain number of chromatographic runs.

Generally, for checking the applicability of an instrument method (i.e., a chromatographic procedure) to a given (current) fluidic configuration of a chromatography instrumentation or system, it may be assured that the maximum resulting flow, which is applied by the instrument methods f_{method,max} does not exceed the maximum applicable flow f_{system,max} for this instrumentation. Hence, the following condition may be fulfilled:

$${f}_{method , max} < {f}_{system , max}$$

Generally, it will be understood that the flow and the pressure are related to one another by means of the fluidic resistance. That is, the above equation is equivalent to the equation

$${P}_{method , max} < {P}_{system , max}$$

where P_{method,max} is the maximal expected pressure for a method or procedure and P_{system,max} is the maximum pressure of the system.

Moreover, a relative difference A between the two values f_{method,max} and f_{system,max} may be used. This may be an indication for the robustness of the instrument method with respect to the flow/pressure limitations of the given (current) chromatography instrumentation.

$$Δ = ( {f}_{system , max} - {f}_{method , max} ) / {f}_{system , max}$$

It should be understood that a corresponding consideration also applies to

$$Δ = ( {P}_{system , max} - {P}_{method , max} ) / {P}_{system , max}$$

Δ may generally be referred to as a distance from an end value. Again, the maximum flow of the system is f_{system,max} and/or the maximum pressure of the system may be P_{system,max}. In other words, there is the boundary condition that the maximum flow/pressure of the procedure is in a range having an upper limit of f_{system,max} (for the flow) and/or a P_{system,max} (for the pressure). The difference A may thus be referred to as a distance and more particularly a relative distance from an end of the range.

Generally, low values for A are indicative of workflows that result in an operation of the instrumentation close to its maximum operating conditions. Consequently, already a minor increase of the system backpressure R_{sys} may cause the system to exceed to upper pressure limit. Thus, unless required for applicative reasons (separation efficiency, throughput etc.) it may be desirable to operate a given system at flow rates considerably below f_{system,max} as this would be more tolerant to increases in backpressure e.g. due to agglomeration of particulates at the separation column. The latter is particularly true for the analysis of samples that are prone to particulate matters.

For example, if the maximum system flow rate f_{system,max} is 200 μL/min and the maximum expected flow rate of an chromatographic procedure is 120 μL/min, the relative distance A would be 0.4, and this would allow an increase of 80 μL/min before reaching the limit allowed by the maximum system flow rate f_{system,max}. Operating the system under such conditions would thus be much more robust than operating the system with a chromatographic procedure with an expected flow rate of 190 μL/min, where the relative distance would only be 0.05.

Therefore, it may be beneficial to highlight values such as f_{system,max}, f_{method,max} and Δ to the user by means of the output device 204 during editing of an instrument method. The latter would allow the user to balance between requirements such as throughput and robustness based on different quality and purity of samples.

Again with more particular reference to FIG. 1, it will be understood that the data processing device 202 is operatively coupled both to the chromatography system 100 (and more particularly to the controller 112 and to the detector 110), to the data input device 206 and to the data output device 204.

There is at least one chromatographic procedure present on the data processing device 202. The chromatographic procedure is defined by means of a plurality of parameters, e.g., flow rate, maximum pressure, solvent type, and column temperature. For example, the parameters may be input by a user by means of the input device 206. However, it will be understood that it is also possible that the parameters are not input by the user, but are present on a memory.

The data processing device 202 validates the parameters. This validating comprises the data processing device 202 checking whether at least one boundary condition is met. For example, the data processing device 202 may determine an expected pressure by means of the flow rate, the solvent type and the column temperature, and may compare this expected pressure to the maximum pressure. In this case, the boundary condition is whether the expected pressure does not exceed the maximum pressure. The data output device 204 may output the result of this validation. In particular, it may output if the validation fails, i.e., if the boundary condition is not met.

Furthermore, in embodiments of the present technology, the data processing device may also determine a distance or safety margin A indicating a (relative) difference to an end of the boundary condition. In the described example, this distance A may be a relative distance from the maximum pressure. This distance A may also be output to the user by means of the output device 204. For example, if the distance is below a threshold of, e.g., 0.3, the output device may also output a notification to the user that the intended procedure is operated close to the limits of the boundary condition and ask the user to confirm whether such an operation is intended.

Afterwards, i.e., after a successful validation (and optionally after the user confirming the operation close to the boundary condition), data may be sent from the data processing device 202 to the controller 112, and the controller 112 may control the chromatography system 100 to execute the chromatographic procedure.

Overall, embodiments of the present technology thus allow a chromatographic procedure (or a plurality of such procedure) to be aptly validated before performing the procedure(s). Thus, only procedures that have been successfully validated are performed, resulting in less frequent failures of the chromatography system, and thus in a more efficient usage.

Whenever a relative term, such as “about”, “substantially” or “approximately” is used in this specification, such a term should also be construed to also include the exact term. That is, e.g., “substantially straight” should be construed to also include “(exactly) straight”.

Whenever steps were recited in the above or also in the appended claims, it should be noted that the order in which the steps are recited in this text may be accidental. That is, unless otherwise specified or unless clear to the skilled person, the order in which steps are recited may be accidental. That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one or more steps (Y1), . . . , followed by step (Z). Corresponding considerations apply when terms like “after” or “before” are used.

While in the above, preferred embodiments have been described with reference to the accompanying drawings, the skilled person will understand that these embodiments were provided for illustrative purpose only and should by no means be construed to limit the scope of the present invention, which is defined by the claims.

1. A method to validate at least one chromatographic procedure, wherein the method comprises:
a data processing device validating a plurality of parameters relating to the at least one chromatographic procedure, wherein the validating comprises the data processing device checking whether at least one boundary condition is met.

2. The method according to claim 1, wherein for each chromatographic procedure, the plurality of parameters comprises at least one flow rate and at least one pressure limit.

3. The method according to claim 2, wherein for each chromatographic procedure, the plurality of parameters comprises at least one of the following:
at least one solvent composition; and
at least one column temperature.

4. The method according to claim 3,
wherein for each chromatographic procedure, the plurality of parameters comprises at least one sample drawing rate, a solvent needle washing composition, and/or a procedure duration.

5. The method according to claim 2,
wherein the validating comprises determining an operational pressure, wherein the determining is based on the at least one flow rate, and wherein the at least one boundary condition comprises the operational pressure being in a pressure range defined by the at least one pressure limit; or
wherein the validating comprises determining at least one flow rate limit, wherein the determining is based on the at least one pressure limit, and wherein the at least one boundary condition comprises the at least one flow rate being in a flow rate range defined by the at least one flow rate limit.

6. The method according to claim 3,
wherein the validating comprises determining an operational pressure, wherein the determining is based on the at least one flow rate, and wherein the at least one boundary condition comprises the operational pressure being in a pressure range defined by the at least one pressure limit; or
wherein the validating comprises determining at least one flow rate limit, wherein the determining is based on the at least one pressure limit, and wherein the at least one boundary condition comprises the at least one flow rate being in a flow rate range defined by the at least one flow rate limit;
wherein determining the operational pressure or determining the at least one flow rate limit is based on the at least one solvent composition and/or on the at least one column temperature.

7. The method according to claim 5,
wherein determining the operational pressure or determining the at least one flow rate limit is based on at least one fluidic resistance of a system for performing the at least one chromatographic procedure, wherein the at least one fluidic resistance of the system is determined at different times.

8. The method according to claim 1,
wherein at least one boundary condition is defined by a range with at least one end,
wherein the method further comprises
the data processing device determining a distance from the at least one end.

9. The method according to claim 1, wherein the method further comprises:
the data processing device receiving at least some of the parameters by a user input.

10. The method according to claim 1, wherein the method further comprises:
the data processing device retrieving at least some of the parameters from a memory, these parameters relating to parameters of at least one previously defined chromatographic procedure.

11. The method according to claim 1, wherein the method further comprises:
if the validation fails, a user interface outputting an error message to a user.

12. The method according to claim 8,
a user interface outputting the distance to the user.

13. The method according to claim 1, wherein the method further comprises:
after a successful validation, a chromatographic system performing the at least one chromatographic procedure.

14. A system comprising a data processing device, wherein the system is configured to perform a method to validate at least one chromatographic procedure, wherein the method comprises:
The data processing device validating a plurality of parameters relating to the at least one chromatographic procedure, wherein the validating comprises the data processing device checking whether at least one boundary condition is met.

15. A computer program comprising instructions which, when the program is executed by a data processing device, cause the data processing device to carry out a method to validate at least one chromatographic procedure, wherein the method comprises:
a data processing device validating a plurality of parameters relating to the at least one chromatographic procedure, wherein the validating comprises the data processing device checking whether at least one boundary condition is met.
